(19) United States
(12) Patent Application Publication
(10) Pub. No.: US 2020/0072615 A1
(43) Pub. Date: Mar. 5, 2020

(54) POSITIONING SYSTEM

(71) Applicant: KABUSHIKI KAISHA TOKAI RIKA DENKI SEISAKUSHO, Niwa-gun, Aichi (JP)

(72) Inventors: Yuki KONO, Aichi (JP); Hiroaki KOJIMA, Aichi (JP); Masayuki KAWAMURA, Aichi (JP); Daisuke SENZAKI, Aichi (JP)

(21) Appl. No.: 16/489,093

(22) PCT Filed: Feb. 16, 2018
(86) PCT No.: PCT/JP2018/005578

§ 371 Date: Aug. 27, 2019

(30) Foreign Application Priority Data
Mar. 2, 2017 (JP) 2017-039407

(51) Int. Cl. G01C 21/26; G08G 1/005

(52) U.S. Cl. CPC G01C 21/26; G08G 1/005

(57) ABSTRACT

A positioning system includes a detector arranged in a terminal to detect a dynamic physical quantity generated at the terminal, and a position calculator that obtains a position of the terminal when the terminal is moved relative to a communication peer. The detector includes a direction detector that detects a movement direction of the terminal, and a movement change amount detector that detects a movement change amount of the terminal.

### TECHNICAL FIELD

The present invention relates to a positioning system that obtains the position of an electronic key.

### BACKGROUND ART

One type of a positioning system known in the prior art is a car finder device that notifies a user of the position of a vehicle parked in, for example, a large parking lot like those in the suburbs. Such type of a car finder device may use a global positioning system (GPS). In such a case, when leaving the vehicle, the user needs to perform an action for GPS-registering the vehicle position, which is where position monitoring is initiated, by activating a switch of the electronic key.

### PRIOR ART DOCUMENT

### Patent Document

Patent Document 1: Japanese Laid-Open Patent Publication No. 2007-241472

### SUMMARY OF THE INVENTION

### Problems that are to be Solved by the Invention

In this case, the GPS is used to find a position. Thus, the electronic key consumes a large amount of current. Further, the function cannot be used in an underground parking lot that cannot be reached by the GPS.

It is an object of the present invention to provide a positioning system that can obtain the position of a terminal by consuming only a small amount of current.

### Means for Solving the Problem

A positioning system that solves the above problem includes a detector arranged in a terminal to detect a dynamic physical quantity generated at the terminal and a position calculator that obtains a position of the terminal when the terminal is moved relative to a communication peer.

With the present configuration, the position of the terminal can be obtained from the output of the detector formed by a sensor or the like that consumes only a small amount of power. Thus, for example, compared with when obtaining the position of the terminal with a member that consumes a large amount of current such as a GPS device, the position of the terminal can be obtained with less current consumption.

Preferably, the positioning system includes a direction detector that detects a movement direction of the terminal and a movement change amount detector that detects a movement change amount of the terminal. With this configuration, the position of the terminal can be accurately obtained using the outputs of the direction detector and the movement change amount detector.

Preferably, in the positioning system, the position calculator obtains the position of the terminal by cyclically repeating calculation of a vector of which a vector direction is a movement direction of the terminal and a vector length is a movement change amount of the terminal. With this configuration, the position of the terminal can be obtained through a simple calculation of the vector on coordinates using the outputs of the direction detector and the movement change amount detector. Accordingly, the position of the terminal is readily detected and does not require time.

Preferably, in the positioning system, the position calculator constructs a polygon including a side of which a perpendicular bisector is the vector and cyclically repeats calculation of the polygon in correspondence with calculation of the vector to obtain the position of the terminal. With this configuration, polygons can be connected to indicate a movement path of the terminal so that the user is notified of the movement path of the terminal that is easy to understand.

Preferably, the positioning system includes a finder function portion that calculates a positional relationship with the communication peer from the position of the terminal obtained by the position calculator and notifies a user of a position of the communication peer based on the positional relationship. With this configuration, the user who is carrying the terminal can be properly notified where the communication peer is located.

Preferably, the positioning system includes an actuation controller that automatically transmits an actuation request from the terminal to the communication peer in accordance with the position of the terminal obtained by the position calculator to actuate the communication peer in a mode corresponding to the actuation request. With this configuration, the actuation request is automatically transmitted from the terminal in accordance with the distance between the terminal and the communication peer. This allows the communication peer to be actuated without the need to operate the terminal in an operation-free manner. This is advantageous from the viewpoint of user convenience.

Preferably, the positioning system includes a malicious communication establishment prevention portion that disables communication between the terminal and the communication peer when a distance of the terminal and the communication peer is greater than or equal to a specified amount. With this configuration, for example, even when someone uses a relay or the like and attempts to establish communication between the terminal and the communication peer that are far from each other, communication cannot be established if the distance between the terminal and the communication peer is greater than or equal to the specified amount. Consequently, it will be difficult to establish malicious communication when using a relay or the like.

### Effects of the Invention

The present invention provides a positioning system that can obtain the position of a terminal by consuming only a small amount of current.

### BRIEF DESCRIPTION OF THE DRAWINGS

FIG. 1 is a diagram illustrating a first embodiment of a positioning system.

FIG. 2 is a diagram illustrating a situation in which an electronic key (user) is inside a vehicle.

FIG. 3 is a diagram illustrating a situation in which the electronic key (user) exits the vehicle.

FIG. 4 is a diagram illustrating a vector (polygon) used to obtain a movement route of the electronic key.

FIG. 5A is a schematic diagram illustrating the movement route of the electronic key obtained from the vectors (polygons), and FIG. 5B is a coordinate diagram illustrating the movement route of the electronic key.

FIG. 6 is a coordinate diagram illustrating the separated distance of the vehicle and the electronic key.

FIG. 7 is a diagram illustrating a specific example in which the user is notified of the position of the vehicle with the finder function.

FIG. 8 is a diagram illustrating a second embodiment of a positioning system.

FIG. 9A is a schematic diagram illustrating a situation in which a vehicle door is automatically unlocked when approaching the vehicle door, and FIG. 9B is a schematic diagram illustrating a situation in which the vehicle door is automatically locked when moving away from the vehicle door.

FIG. 10 is a diagram illustrating a third embodiment of a positioning system.

FIGS. 11A and 11B are diagrams illustrating the operation of the positioning system.

FIG. 12A is a schematic diagram illustrating a further embodiment for obtaining the position of the electronic key in which the movement route of the electronic key is obtained from vectors (polygons), and FIG. 12B is a coordinate diagram illustrating the movement route of the electronic key.

### EMBODIMENTS OF THE INVENTION

### First Embodiment

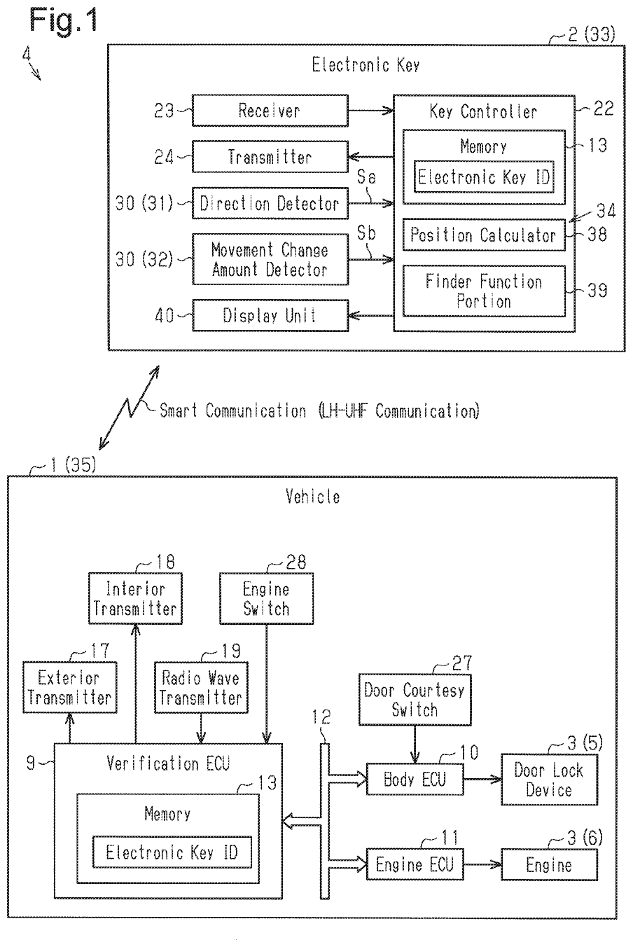

A first embodiment of a positioning system will now be described with reference to FIGS. 1 to 7.

As illustrated in FIG. 1, a vehicle 1 includes an electronic key system 4 that performs ID verification with an electronic key 2 through wireless communication to permit or perform actuation of an on-board device 3. The electronic key system 4 is a key operation-free system that performs ID verification (smart verification) with the electronic key 2 through short range wireless communication when communication is established with the vehicle 1. The electronic key system 4 automatically performs ID verification (smart verification) without the electronic key 2 being directly operated. The on-board device 3 is, for example, a door lock device 5 or an engine 6.

The vehicle 1 includes a verification electronic control unit (ECU) 9 that performs ID verification, a body ECU 10 that manages the power for on-board electric devices, and an engine ECU 11 that controls the engine 6. The ECUs are electrically connected by a communication line 12 in the vehicle. The communication line 12 is, for example, a controller area network (CAN) or a local interconnect network (LIN). The verification ECU 9 includes a memory 13. An electronic key ID of the electronic key 2, which is registered to the vehicle 1, is registered to the memory 13 of the verification ECU 9. The body ECU 10 controls the door lock device 5 to lock and unlock the vehicle door 14.

The vehicle 1 includes an exterior transmitter 17 that is capable of transmitting radio waves out of the passenger compartment, an interior transmitter 18 that is capable of transmitting radio waves in the passenger compartment, and a radio wave receiver 19 that is capable of receiving radio waves in the vehicle 1. The exterior transmitter 17 and the interior transmitter 18 transmit radio waves in the low frequency (LF) band. The radio wave receiver 19 receives radio waves in the ultrahigh frequency (UHF) band. The electronic key system 4 performs LH-UHF bidirectional communication.

The electronic key 2 includes a key controller 22 that controls actuation of the electronic key 2, a receiver 23 that receives radio waves in the electronic key 2, and a transmitter 24 that transmits radio waves from the electronic key 2. The key controller 22 includes a memory (not illustrated). The electronic key ID that is unique to the electronic key 2 is written to and stored in the memory. The receiver 23 is capable of receiving LF radio waves. The transmitter 24 is capable of transmitting UHF radio waves.

When the vehicle 1 is parked and the exterior transmitter 17 transmits a wake signal for activating the electronic key 2 on LF radio waves, if the electronic key 2 enters the communication area of the wake signal, the electronic key 2 is activated from a standby state and to initiate smart communication. In this case, the verification ECU 9 performs ID verification (exterior smart verification) with the activated electronic key 2. The smart verification includes, for example, electronic key ID verification that checks whether the electronic key ID is correct, challenge-response authentication that uses a unique key code (encryption code), and the like. The verification ECU determines that ID verification was successful when the verification or authentication are accomplished and permits or performs locking or unlocking of the vehicle door 14 with the body ECU 10.

When, for example, a door courtesy switch 27 detects that the user has entered the vehicle, the verification ECU 9 transmits a wake signal from the interior transmitter 18 instead of the exterior transmitter 17. When the electronic key 2 receives the wake signal, ID verification (interior smart verification), which is similar to the exterior smart verification, is initiated. After determining that the interior smart verification has been accomplished, the verification ECU 9 permits an operation for changing the state of power (engine starting operation) with an engine switch 28.

The electronic key system 4 (electronic key 2) includes a positioning system 34 that obtains the position of a terminal 33 relative to a communication peer 35 of the terminal 33 based on a detection result of a detector 30 that detects a dynamic physical quantity of the terminal 33. In the present example, the terminal 33 is the electronic key 2, and the communication peer 35 is the vehicle 1. Preferably, the detector 30 of the present example is a direction detector 31 and a movement change amount detector 32 that are arranged in the terminal 33.

The positioning system 34 of the present example obtains the position of the terminal 33 relative to the communication peer 35 (vehicle 1 in present example) of the terminal 33 based on a detection result of the direction detector 31 and a detection result of the movement change amount detector 32. The positioning system 34 of the present example implements a finder function (car finder function) that notifies the user of the position of the communication peer 35 relative to the present position of the terminal 33.

The direction detector 31 detects the movement direction of the terminal 33 and is formed by, for example, a geomagnetic sensor. The direction detector 31 outputs a detection signal Sa corresponding to the detected movement direction to the key controller 22.

The movement change amount detector 32 detects the movement change amount of the terminal 33 and is formed by, for example, an acceleration sensor. The movement change amount detector 32 outputs a detection signal Sb corresponding to the detected movement change amount (acceleration) to the key controller 22.

The positioning system 34 includes a position calculator 38 that obtains the position of the terminal 33 based on the detection signals Sa and Sb of the direction detector 31 and the movement change amount detector 32. The position calculator 38 is arranged in the key controller 22. The position calculator 38 obtains the movement direction of the electronic key 2 based on the detection result of the direction detector 31 and obtains the movement change amount (speed) of the electronic key 2 based on the detection result of the movement change amount detector 32 to calculate the position (movement route R) of the electronic key 2.

The positioning system 34 includes a finder function portion 39 that notifies the user of the position of the communication peer 35 relative to the present position of the terminal 33. The finder function portion39 is arranged in the key controller 22. The finder function portion 39 calculates the positional relationship with the communication peer 35 (in present example, vehicle 1) from the position of the terminal 33 obtained by the position calculator 38 and notifies the user of the position of the communication peer 35 based on the positional relationship. The finder function portion 39 notifies the user of the position of the communication peer 35 with, for example, a display unit 40 arranged on the electronic key 2. The display unit 40 includes, for example, a display arranged on the electronic key 2.

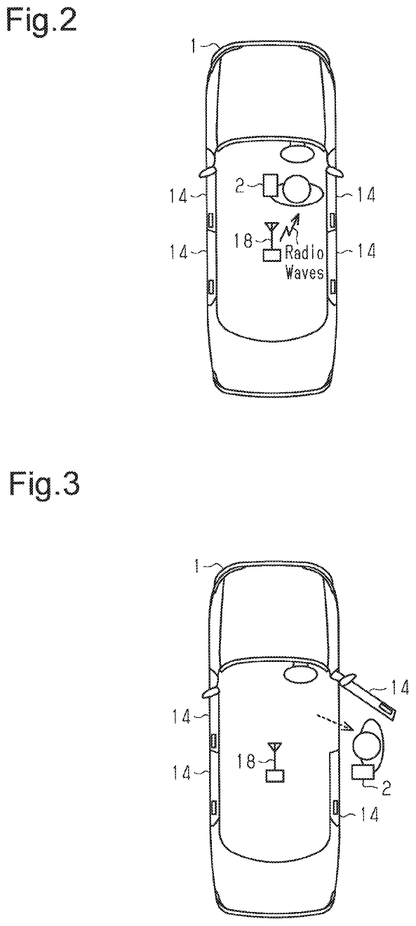

The operation and advantages of the positioning system 34 in accordance with one embodiment of the present invention will now be described with reference to FIGS. 2 to 7.

Referring to FIG. 2, the position calculator 38 checks whether the electronic key 2 has received the radio waves (e.g., LF radio waves) transmitted from the interior transmitter 18 to monitor whether the user (electronic key 2) is located in the vehicle. Preferably, the communication performed during position monitoring is, for example, interior smart verification communication. The monitoring of whether the user is present in the vehicle may be performed, for example, periodically when the vehicle is driven or performed when the vehicle is powered off (IG off).

FIG. 3 illustrates a case in which the user exits the vehicle 1. The position calculator 38 determines that the user, who is carrying the electronic key 2, has exited the vehicle 1 when detecting that the radio waves transmitted from the interior transmitter 18 has been received with a signal intensity that is lower than a specified value. Exiting from the vehicle may also be determined when the vehicle 1 acknowledges exiting from the vehicle based on, for example, the detection signal of the door courtesy switch 27. In this case, the vehicle 1 may establish communication with the electronic key 2 to notify the electronic key 2 of the exiting.

When acknowledging that the user has exited the vehicle, the position calculator 38 initiates position calculation. In the present example, the position calculator 38 obtains the movement direction of the electronic key 2 based on the detection signal Sa received from the direction detector 31 and obtains the movement change amount (movement speed) of the electronic key 2 based on the detection signal Sb received from the movement change amount detector 32.

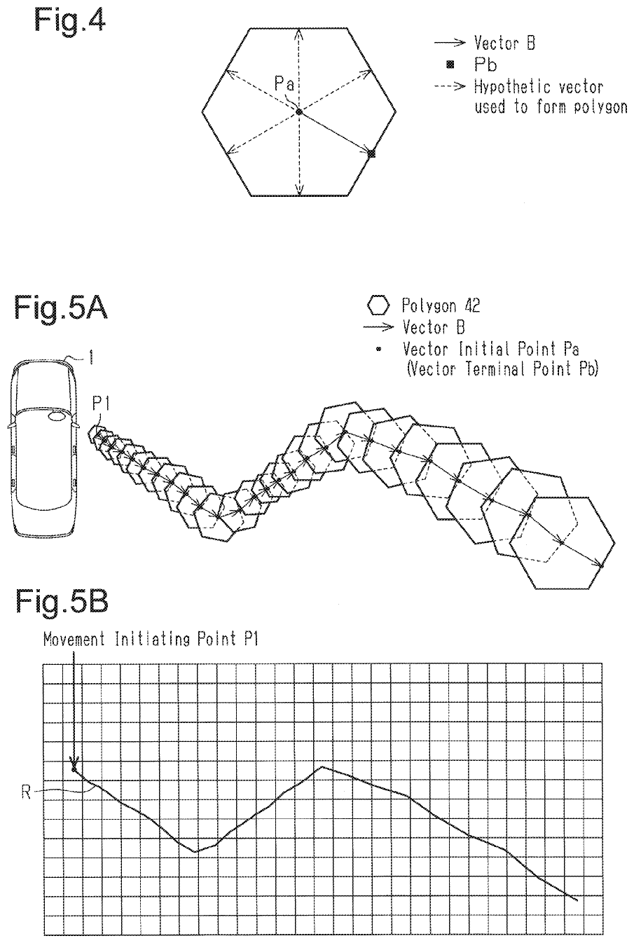

Referring to FIG. 4, when obtaining the position of the electronic key 2 based on the detection signals Sa and Sb of the direction detector 31 and the movement change amount detector 32, the position calculator 38 calculates a vector B of which the vector direction is the movement direction of the electronic key 2 and the vector length is the movement change amount (movement speed) of the electronic key 2. The vector B includes the movement points of a vector initial point Pa acquired prior to movement and a vector terminal point Pb obtained through a calculation. The position calculator 38 calculates the vector B and constructs a polygon 42 including a side 41 of which the perpendicular bisector is the vector B. The polygon 42 of the present example is, for example, a hexagon. In this manner, the position calculator 38 calculates discretization data that expresses the movement amount of the position of the electronic key 2 as relative coordinates on the two axes of X and Y.

Referring to FIG. 5A, the position calculator 38 cyclically repeats the calculation of the vector B having a direction and length corresponding to the movement direction and the movement speed of the electronic key 2 to obtain the route in which the electronic key 2 is moved from a movement initiating point Pl. In the present example, the position calculator 38 cyclically repeats the calculation of the vector B having a direction and length corresponding to the movement direction and the movement speed of the electronic key 2 using the vector terminal point Pb as a new vector initial point Pa to obtain the route in which the electronic key 2 is moved.

The position calculator 38 sequentially connects the vector B (hexagon) obtained in each cycle to construct a movement locus R of the electronic key 2 using coordinates as illustrated in FIG. 5B. More specifically, the position calculator 38 collects discretization data obtained through the calculation of the relative coordinates in each cycle and constructs a hypothetical space containing the movement locus R of the electronic key 2 based on the discretization data. The movement locus R corresponds to information indicating with the X-Y coordinates how the electronic key 2 has moved. The discretization data is formed by a data group in which the position of the electronic key 2 is converted to numerical values on coordinates. The movement locus R is not limited to the connected, cyclically-generated vectors B and may be expressed by, for example, connected hexagons.

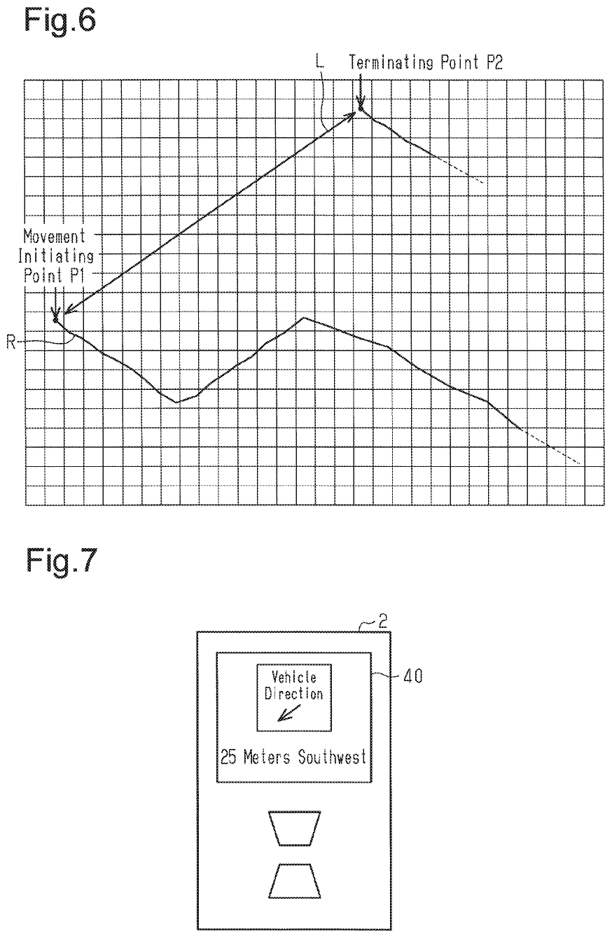

Referring to FIG. 6, when the user uses the finder function with the electronic key 2, the position calculator 38 sets the position where the finder function is used as a terminating point P2 of the movement of the electronic key 2 and calculates the separated distance L of the movement initiating point P1 and the terminating point P2. The X-Y coordinates are points plotted on X-Y coordinate axes. Thus, as long as the movement initiating point P1 and terminating point P2 are obtained on the X-Y coordinates, the separated distance L can easily be obtained.

As illustrated in FIG. 7, after the separated distance L of the movement initiating point P1 and terminating point P2 are calculated, the finder function portion 39 shows the position of the vehicle 1 on the display unit 40 of the electronic key 2. In the present example, the car finder shows, for example, the distance from the electronic key 2 to the vehicle 1 and the direction in which the vehicle 1 is located as viewed from the electronic key 2 (vehicle direction). Since the electronic key 2 includes the direction detector 31, the vehicle direction may be calculated using the detection signal Sa of the direction detector 31.

In the present example, the position of the electronic key 2 can be obtained from the output of the detector 30 that is formed by a sensor or the like that consumes only a small amount of power. Thus, for example, compared with when obtaining the position of the electronic key 2 with a member that consumes a large amount of current such as a GPS device, the position of the electronic key 2 can be obtained with less current consumption.

In the present example, the car finder function is implemented with a system (mico-order) that consumes a small amount of current. Further, the position monitoring of the electronic key 2 is initiated when the user exits the vehicle 1. Thus, the car finder function can be activated without any burden on the user.

The detector 30 includes the direction detector 31, which detects the movement direction of the electronic key 2 and the movement change amount detector 32, which detects the movement change amount of the electronic key 2. Thus, the position of the electronic key 2 can be accurately obtained by using the outputs (detection signals Sa and Sb) of the direction detector 31 and the movement change amount detector 32.

The position calculator 38 obtains the position of the electronic key 2 by cyclically repeating the calculation of the vector B of which the vector direction is the movement direction of the electronic key 2 and the vector length is the movement change amount of the electronic key 2. Thus, the position of the electronic key 2 can be obtained through a simple process of calculating the vector B on coordinates using the outputs of the direction detector 31 and the movement change amount detector 32. Accordingly, the position of the electronic key 2 is readily detected and does not require time.

The position calculator 38 constructs the polygon 42 (hexagon in present example) including the side 41 of which the perpendicular bisector is the vector B and cyclically repeats the calculation of the polygon 42 in correspondence with the calculation of the vector B to obtain the position of the electronic key 2. Thus, polygons 42 can be connected to indicate the movement locus R of the electronic key 2 so that the user is notified of the movement locus R of the electronic key 2 that is easy to understand.

The positioning system 34 of the present example implements the finder function that notifies the user of the position of the vehicle 1 as viewed from the electronic key 2. Thus, the user who is carrying the electronic key 2 can be properly notified where the vehicle 1 is located.

### Second Embodiment

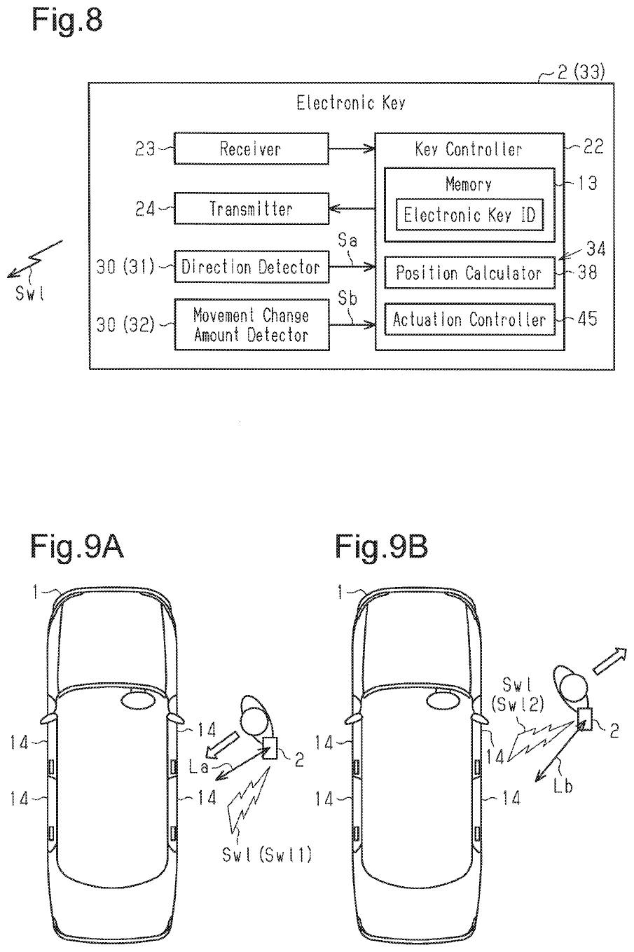

A second embodiment will now be described with reference to FIGS. 8, 9A, and 9B. The second embodiment is an example in which the positioning system 34 is used in a manner that differs from the first embodiment. Therefore, same reference numerals are given to those components that are the same as the corresponding components of the first embodiment. The description will focus on the differences from the first embodiment.

As illustrated in FIG. 8, the positioning system 34 of the present example implements a finder function (car finder function) that actuates the communication peer 35 with the terminal 33 in accordance with the distance between the terminal 33 and the communication peer 35. In this case, the positioning system 34 includes an actuation controller 45 that implements a remote operation function in the electronic key 2. The actuation controller 45 is arranged in the key controller 22. The actuation controller 45 automatically transmits an actuation request Swl from the terminal 33 to the communication peer 35 in accordance with the position of the terminal 33 obtained by the position calculator 38 to actuate the communication peer 35 in a mode corresponding to the actuation request Sw.

The remote operation function of the present example is an automatic locking-unlocking function that automatically locks and unlocks the vehicle door 14. Thus, the actuation controller 45 automatically transmits a door lock request or a door unlock request as the actuation request Sw from the transmitter 24 to the vehicle 1 in accordance with the separated distance L of the vehicle 1 and the electronic key 2. In the present example, the locking and unlocking of the vehicle door 14 is switched by a remote operation performed with the electronic key 2 as a wireless operation. Thus, the exterior smart verification function (exterior transmitter 17) may be omitted.

FIG. 9A illustrates a case in which the electronic key 2 approaches the vehicle 1 when the vehicle 1 is in a parked state (door locked and engine stopped). In this case, the actuation controller 45 automatically transmits a door unlock request Swl1 from the transmitter 24 when determining that the separated distance L of the vehicle 1 and the electronic key 2 (separated distance L of movement initiating point P1 and terminating point P2) is less than a specified value La for door unlock determination. The door unlock request Swl1 includes the electronic key ID and a command demanding the vehicle door 14 to be unlocked.

When the radio wave receiver 19 receives the door unlock request Swl1 automatically transmitted from the electronic key 2, the verification ECU 9 verifies the electronic key ID included in the door unlock request Swl1. When verification of the electronic key ID is accomplished, the verification ECU 9 unlocks the vehicle door 14 with the body ECU 10 in accordance with the command demanding unlocking. This permits entrance into the vehicle.

FIG. 9B illustrates a case in which the electronic key 2 moves away from the vehicle 1 when the vehicle 1 is in a parked state (door unlocked and engine stopped). In this case, the actuation controller 45 automatically transmits a door lock request Swl2 from the transmitter 24 when determining that the separated distance L is greater than a specified value Lb for door lock determination. The specified value Lb for door lock determination may be the same as or differ from the specified value La for door unlocking. The door lock request Swl2 includes the electronic key ID and a command demanding the vehicle door 14 to be locked.

When the radio wave receiver 19 receives the door lock request Swl2 automatically transmitted from the electronic key 2, the verification ECU 9 verifies the electronic key ID included in the door lock request Swl2. When verification of the electronic key ID is accomplished, the verification ECU 9 locks the vehicle door 14 with the body ECU 10 in accordance with the command demanding locking. This allows the vehicle door 14 to be shifted to a lock state.

In the present example, the positioning system 34 implements the remote operation function that actuates the vehicle 1 (locks and unlocks vehicle door 14 in present example) in accordance with the separated distance L of the vehicle 1 and the electronic key 2. In this manner, the actuation request Swl is automatically transmitted from the electronic key 2 to the vehicle 1 in accordance with the separated distance L of the vehicle 1 and the electronic key 2. This allows the vehicle 1 to be actuated without the need to operate the electronic key 2, that is, in an operation-free manner. This is advantageous from the viewpoint of user convenience. Further, since the distance between the vehicle 1 and the electronic key 2 can be measured, the action taken by the user can be estimated (determination of movement toward or away from vehicle 1).

The cycle for generating the vector B may be changed in accordance with the separated distance L. As a specific example, the vector B may be generated, for example, in more cycles when the electronic key 2 is located near the vehicle 1 than when the electronic key 2 is far from the vehicle 1. In this regard, if the electronic key 2 is near the vehicle 1 when switching locking and unlocking of the vehicle door 14, it is preferable that the position of the electronic key 2 be accurately obtained. This becomes possible by allowing for switching of the cycle for generating the vector B.

### Third Embodiment

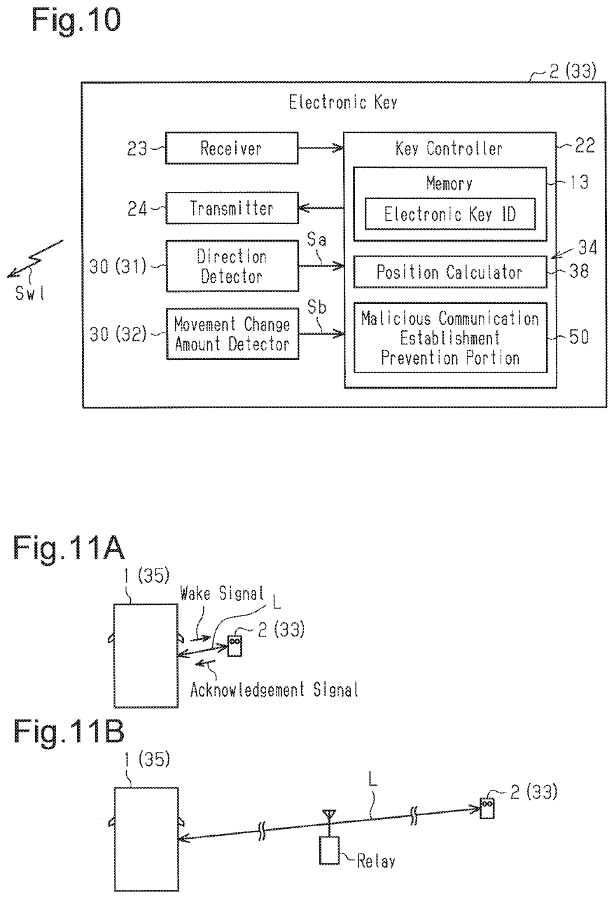

A third embodiment will now be described with reference to FIGS. 10, 11A, and 11B. The present example is an example applying the concept of the present invention to cope with malicious communication establishment between the vehicle 1 and the electronic key 2. The present example will be described focusing on the differences from the first and second embodiments.

Referring to FIG. 10, the positioning system 34 of the present example implements a malicious communication establishment prevention function that prevents malicious communication establishment between the terminal 33 and the communication peer 35. In the present example, the positioning system 34 includes a malicious communication establishment prevention portion 50 that prevents malicious communication between the terminal 33 and the communication peer 35 based on the position calculation result obtained by the position calculator 38. The malicious communication establishment prevention portion 50 is arranged in the key controller 22. The malicious communication establishment prevention portion 50 disables communication (e.g., smart communication) between the vehicle 1 and the electronic key 2 when the separated distance L of the vehicle 1 and the electronic key 2 obtained by the position calculator 38 is greater than or equal to a specified amount.

FIG. 11A illustrates a case in which the electronic key 2 receives a wake signal periodically transmitted from the vehicle 1 when the separated distance L of the vehicle 1 and the electronic key 2 is less than a specified value. The malicious communication establishment prevention portion 50 allows communication (e.g., smart communication) between the vehicle 1 and the electronic key 2 when the separated distance L of the vehicle 1 and the electronic key 2 obtained by the position calculator 38 is less than the specified value. Thus, when the electronic key 2 receives a wake signal that is LF-transmitted from the vehicle 1, the electronic key 2 performs an action for transmitting a response (acknowledgment signal) to the wake signal. That is, the electronic key 2 performs smart verification (exterior smart verification) when receiving a wake signal from the vehicle 1. Then, when smart verification (exterior smart verification) is accomplished, locking or unlocking of the vehicle door 14 is permitted or performed.

FIG. 11B illustrates a case in which the electronic key 2 receives a wake signal periodically transmitted from the vehicle 1 when the separated distance L of the vehicle 1 and the electronic key 2 is greater than or equal to a specified value. Such a case may occur when, for example, someone arranges a relay or the like between the vehicle 1 and the electronic key 2 so that the LF radio waves of the vehicle 1 reach the electronic key 2.

The malicious communication establishment prevention portion 50 does not allow communication (e.g., smart communication) between the vehicle 1 and the electronic key 2 when the separated distance L is greater than or equal to the specified value. Thus, when the electronic key 2 receives a wake signal that is LF-transmitted from the vehicle 1, the electronic key 2 will not return a response (acknowledgment signal) to the wake signal. That is, the electronic key 2 will not perform smart verification (exterior smart verification) even when receiving a wake signal from the vehicle 1. Consequently, even if someone attempts to establish smart communication in a malicious manner using a relay or the like, the communication is determined as being malicious and smart communication cannot be established.

In the present example, the separated distance L of the electronic key 2 from the vehicle 1 is obtained based on the detection signal of the detector 30, and smart communication is not established when the separated distance L is greater than or equal to the specified value. Thus, for example, even when someone uses a relay or the like and attempts to establish communication between the vehicle 1 and the electronic key 2 that are far from each other, communication is not established if the distance between the vehicle 1 and the electronic key 2 is greater than or equal to a specified amount. Consequently, it will be difficult to establish malicious communication using a relay or the like.

The embodiments are not limited to the configuration described above and may be modified as described below.

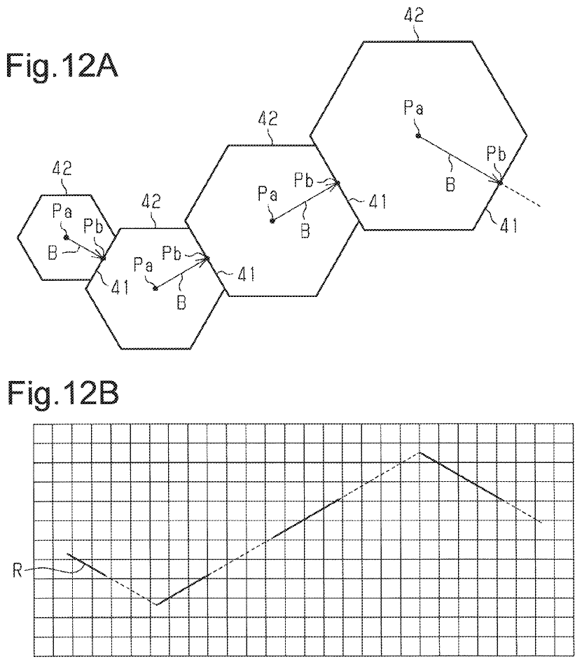

In each of the embodiments, as illustrated in FIGS. 12A and 12B, the movement locus R of the electronic key 2 may be obtained by arranging adjacent polygons 42 (hexagons) so that their sides 41 overlap. This also accurately obtains the position of the electronic key 2.

In the first embodiment, the car finder function may notify the user of the vehicle position using, for example, a display medium such as electronic paper or the like.

In the first embodiment, the indication shown on the display unit 40 is not limited to the mode described in the embodiment and may be modified in any manner.

In the first embodiment, the notification of the position of the electronic key 2 is not limited to the visual notification using the display unit 40 and may be, for example, a voice notification.

In the first embodiment, the position notification (car finder function) of the vehicle 1 may be implemented, for example, by transmitting position information of the vehicle 1 from the electronic key 2 to a terminal such as a smartphone of the user so that the terminal notifies the user of the position information.

In the second embodiment, it may be determined whether the electronic key 2 is located inside or outside the vehicle.

In the third embodiment, distance information of the separated distance L may be transmitted from the electronic key 2 to the vehicle 1 so that the vehicle 1 performs the determination with the separated distance L (determination comparing separated distance L and specified amount).

The third embodiment may be configured so that the vehicle 1 does not accept a response such as an acknowledgement signal when having determined that smart communication cannot be performed even if the electronic key 2 transmits the response. This will also restrict the establishment of malicious communication with a relay or the like.

In the third embodiment, the vehicle 1 and the electronic key 2 may both perform a determination with the separated distance L (determination comparing separated distance L and specified amount), and the vehicle 1 and the electronic key 2 may both perform the determination of whether to permit communication.

In each embodiment, the vector B may be generated in regular or irregular cycles. Various values may be applied as the cycle for generating the vector B such as a clock cycle of a CPU of the electronic key 2.

In each embodiment, the determination of whether the electronic key 2 is located inside the vehicle may be performed in, for example, any of a variety of modes such as a mode transmitting radio waves from the electronic key 2 at a regular interval and determining that the electronic key 2 is located in the vehicle when receiving the radio waves.

In each embodiment, the indication of whether the user has exited the vehicle 1 may be changed to a mode that is not described in the embodiment.

In each embodiment, the interior smart verification function may be omitted. In this case, there is a need to check that the electronic key 2 is located in the passenger compartment in any other manner. For example, a camera may be used to check that the user (electronic key 2) is present.

In each embodiment, the direction detector 31 may be any member that can detect the movement direction of the terminal 33 such as a magnetic compass, for example.

In each embodiment, the movement change amount detector 32 is not limited to an acceleration sensor and may be changed to, for example, another member such as a speed sensor. The movement change amount may be accordingly changed to any of a variety of parameters.

In each embodiment, the polygon 42 may be generated so that the vector terminal point Pb is the vertex of the polygon 42.

In each embodiment, the polygon 42 may be, for example, a circle.

In each embodiment, the position of the electronic key 2 may be obtained without using the polygon 42.

In each embodiment, the detector 30 is not limited to the direction detector 31 and the movement change amount detector 32 as long as dynamic movement of the terminal 33 can be detected.

In each embodiment, the electronic key system 4 may be a system using, for example, Bluetooth (registered trademark).

In each embodiment, the electronic key system 4 may be modified to any of a variety of modes by changing the frequency, the antenna configuration, the number of antennas, and the communication format.

In each embodiment, the terminal 33 is not limited to the electronic key 2 and may be changed to, for example, another terminal such as a smartphone.

In each embodiment, the communication peer 35 is not limited to the vehicle 1 and only needs to be a device or apparatus that can communicate with the terminal 33.

In each embodiment, the positioning system 34 does not have to be applied to the vehicle 1 and may be used in another device or apparatus.

A technical concept that can be recognized from the above embodiments and modifications will now be described below with the advantage.

(A) A terminal including: a direction detector that detects a movement direction; a movement change amount detector that detects a movement change amount; and a position calculator that obtains a position of the terminal when moved relative to a communication peer based on a detection result of the direction detector and a detection result of the movement change amount detector. Also in this case, the same advantages as the positioning system can be obtained.

### DESCRIPTION OF THE REFERENCE NUMERALS

1) vehicle, 2) electronic key, 30) detector, 31) direction detector, 32) movement change amount detector, 33) terminal, 34) positioning system, 35) communication peer, 38) position calculator, 39) finder function portion, 42) polygon, 45) actuation controller, L) separated distance, B) vector, R) movement locus, Swl) actuation request

1. A positioning system comprising:
a detector arranged in a terminal to detect a dynamic physical quantity generated at the terminal; and
a position calculator that obtains a position of the terminal when the terminal is moved relative to a communication peer.

2. The positioning system according to claim 1, wherein the detector includes a direction detector that detects a movement direction of the terminal, and
a movement change amount detector that detects a movement change amount of the terminal.

3. The positioning system according to claim 1, wherein the position calculator obtains the position of the terminal by cyclically repeating calculation of a vector of which a vector direction is a movement direction of the terminal and a vector length is a movement change amount of the terminal.

4. The positioning system according to claim 3, wherein the position calculator constructs a polygon including a side of which a perpendicular bisector is the vector and cyclically repeats calculation of the polygon in correspondence with calculation of the vector to obtain the position of the terminal.

5. The positioning system according to claim 1, comprising a finder function portion that calculates a positional relationship with the communication peer from the position of the terminal obtained by the position calculator and notifies a user of a position of the communication peer based on the positional relationship.

6. The positioning system according to claim 1, comprising an actuation controller that automatically transmits an actuation request from the terminal to the communication peer in accordance with the position of the terminal obtained by the position calculator to actuate the communication peer in a mode corresponding to the actuation request.

7. The positioning system according to claim 1, comprising a malicious communication establishment prevention portion that disables communication between the terminal and the communication peer when a separated distance of the terminal and the communication peer is greater than or equal to a specified amount.
